(19) United States
(12) Patent Application Publication
(10) Pub. No.: US 2025/0094979 A1
(43) Pub. Date: Mar. 20, 2025

(54) METHOD FOR PROCESSING HOMOMORPHIC ENCRYPTION AND ELECTRONIC APPARATUS

(71) Applicant: CRYPTO LAB INC., Seoul (KR)

(72) Inventor: Jongmin Choi, Seoul (KR)

(21) Appl. No.: 18/805,778

(22) Filed: Aug. 15, 2024

(30) Foreign Application Priority Data
Aug. 16, 2023 (KR) 10-2023-0107010
Aug. 12, 2024 (KR) 10-2024-0107674

(51) Int. Cl. G06Q 20/40; G06Q 30/08; H04L 9/00

(52) U.S. Cl. CPC G06Q 20/401; G06Q 30/08; H04L 9/008

(57) ABSTRACT

An electronic apparatus includes a communicator configured to receive a homomorphic encrypted message including homomorphic encrypted price information for an auction item from each of a plurality of other electronic apparatuses; a memory configured to store at least one instruction; and a processor configured to execute the at least one instruction, in which the processor is configured to sort the plurality of pieces of price information using a sorting method corresponding to an auction method for an auction item, and control the communicator to notify the electronic apparatus corresponding to a seller of price information corresponding to a preset rank among the sorted price information and buyer information corresponding to the price information.

### TECHNICAL FIELD

The present disclosure relates to a method for processing homomorphic encryption that performs an auction procedure in a homomorphically encrypted state to prevent auction information from being exposed even to an intermediary that mediates the auction, and an electronic apparatus.

### BACKGROUND ART

As communication technology develops and electronic apparatuses spread, efforts are continuously made to maintain communication security between the electronic apparatuses. Accordingly, encryption/decryption technology is used in most communication environments.

When messages encrypted by the encryption technology are delivered to the other party, the other party needs to perform decryption in order to use the messages. In this case, the other party wastes resources and time during decrypting the encrypted data. In addition, when the third party hacks messages while the other party temporarily decrypts the messages for operation, there is a problem in that the messages may be easily leaked to the third party.

In order to solve this problem, a homomorphic encryption method is being studied. According to the homomorphic encryption method, even if the operation is performed on encrypted messages themselves without decrypting the encrypted information, it is possible to obtain the same result as the encrypted value after the operation is performed on a plain text. Accordingly, various types of operations may be performed without decrypting the encrypted messages.

An auction is a transaction method in which multiple people or apparatuses submit a bid price for a specific item, and one of users who submitted the bid price is determined to sell the item. In this way, in order to select a successful bidder, the existing brokerage system should perform a process of comparing prices of each bidder, but the existing auction system had the problem that bidder's price information, etc., may be exposed.

### DISCLOSURE

### Technical Solution

Accordingly, the present disclosure is devised to solve the above-described problems, and provides a method for processing homomorphic encryption capable of performing an auction procedure by performing homomorphic encrypting on auction information to prevent auction information from being exposed even to an intermediary mediating an auction.

According to an aspect of the present disclosure, an electronic apparatus includes a communicator configured to receive a homomorphic encrypted message including homomorphic encrypted price information for an auction item from each of a plurality of other electronic apparatuses; a memory configured to store at least one instruction; and a processor configured to execute the at least one instruction, in which the processor is configured to sort a plurality of pieces of price information using a sorting method corresponding to an auction method for the auction item, and control the communicator to notify an electronic apparatus corresponding to a seller of price information corresponding to a preset rank among the sorted price information and buyer information corresponding to the price information.

The processor may be configured to control the communicator to transmit a result of a preset homomorphic operation between price information transmitted from a corresponding electronic apparatus and price information corresponding to the preset rank to each of the plurality of electronic apparatuses.

The preset homomorphic operation may be a homomorphic operation that has a value of 1 or 0 upon decryption depending on whether two pieces of homomorphically encrypted numerical information are identical.

The processor may be configured to generate one merged encrypted message, in which one piece of price information is located in one first slot and the buyer information corresponding to the price information is located in a second slot of the same column, using the plurality of received homomorphic encrypted messages.

The processor may be configured to perform sorting on a column-by-column basis using information within a first slot of the merged encrypted message, and control the communicator to notify the electronic apparatus corresponding to the seller of price information and the buyer information within the column corresponding to the preset rank.

The merged encrypted message may have price information located in the first slot and third slots, and the processor may be configured to perform a preset homomorphic operation between each of the third slots of the sorted merged encrypted message and the price information corresponding to the preset rank, and control the communicator to transmit a result of the preset homomorphic operation in the third slots to each of the plurality of electronic apparatuses.

The processor may be configured to generate the merged encrypted message having the plurality of third slots corresponding to the number of multiple successful bidders when the auction method has multiple successful bidders, and each of the plurality of third slots may perform a preset homomorphic operation between price information with different ranks.

According to another aspect of the present disclosure, a method for processing an encrypted message in an electronic apparatus includes: receiving a homomorphic encrypted message including homomorphic encrypted price information for an auction item from each of a plurality of other electronic apparatuses; sorting the plurality of pieces of price information using a sorting method corresponding to an auction method for the auction item; and notifying an electronic apparatus corresponding to a seller of price information corresponding to a preset rank among the sorted price information and buyer information corresponding to the price information.

The method may further include transmitting a result of a preset homomorphic operation between price information transmitted from a corresponding electronic apparatus and the price information corresponding to the preset rank to each of the plurality of electronic apparatuses.

The preset homomorphic operation may be a homomorphic operation that has a value of 1 or 0 upon decryption depending on whether two pieces of homomorphically encrypted numerical information are identical.

The method may further include: generating one merged encrypted message, in which one piece of price information is located in one first slot and the buyer information corresponding to the price information is located in a second slot of the same column, using the plurality of received homomorphic encrypted messages.

In the sorting, sorting may be performed on a column-by-column basis using information within the first slot of the merged encrypted message, and in the notifying of the electronic apparatus corresponding to the seller, the price information and the buyer information within the column corresponding to the preset rank may be notified to the electronic apparatus corresponding to the seller.

The method may further include: performing a preset homomorphic operation between each of the third slots of the sorted merged encrypted message and the price information corresponding to the preset rank; and transmitting a result of the preset homomorphic operation in the third slot to each of the plurality of electronic apparatuses, in which the merged encrypted message may have price information located in the first slot and third slots.

In the generating of the merged encrypted message, the merged encrypted message having the plurality of third slots corresponding to the number of multiple successful bidders may be generated when the auction method has multiple successful bidders, and in the performing of the preset homomorphic operation, each of the plurality of third slots may perform the preset homomorphic operation between price information with different ranks.

According to still another aspect of the present disclosure, a computer-readable recording medium including a program for executing a method for processing an encrypted message, in which the method for processing an encrypted message may include: receiving a homomorphic encrypted message including homomorphic encrypted price information for an auction item from each of a plurality of other electronic apparatuses; sorting the plurality of pieces of price information using a sorting method corresponding to an auction method for an auction item; and notifying the electronic apparatus corresponding to a seller of price information corresponding to a preset rank among the sorted price information and buyer information corresponding to the price information.

According to various embodiments of the present disclosure as described above, by performing the auction bidding process in the homomorphically encrypted state, it is possible to prevent the successful bidder information, the participant information, etc., from being exposed to the intermediary.

### DESCRIPTION OF DRAWINGS

The above and other aspects, features and advantages of characteristic embodiments of the present disclosure will become more apparent from the following description in conjunction with the accompanying drawings:

FIG. 1 is a diagram for describing an operation of a system according to an embodiment of the present disclosure;

FIG. 2 is a diagram for describing a key distribution operation according to an embodiment of the present disclosure;

FIG. 3 is a diagram for describing an operation of collecting bidding information according to an embodiment of the present disclosure;

FIG. 4 is a diagram for describing an operation of performing a homomorphic operation according to an embodiment of the present disclosure;

FIG. 5 is a diagram for describing an example of merging bidding data according to an embodiment of the present disclosure;

FIG. 6 is a diagram for describing an example of merging bidding data according to another embodiment of the present disclosure;

FIG. 7 is a diagram for describing a process of decrypting an auction result according to an embodiment of the present disclosure;

FIG. 8 is a block diagram illustrating a basic configuration of an electronic apparatus according to the embodiment of the disclosure;

FIG. 9 is a block diagram showing a detailed configuration of the electronic apparatus according to an embodiment of the present disclosure;

FIG. 10 is a flowchart for describing an operation of controlling the electronic apparatus according to an embodiment of the present disclosure; and

FIG. 11 is a flowchart for describing a method for processing an encrypted message in an electronic apparatus according to an embodiment of the present disclosure.

### MODE FOR INVENTION

Hereinafter, the present disclosure will be described in detail with reference to the accompanying drawings. Encryption/decryption may be applied to an information (data) transmission process performed in the present disclosure, if necessary, and all expressions describing the information (data) transmission process in the present disclosure and claims should be interpreted as including cases of encryption/decryption even if not separately stated. In the present disclosure, expressions such as “transmission (delivery) from A to B” or “A receiving from B” include transmission (delivery) or reception with another medium included therebetween, and does not necessarily express only what is directly transmitted (delivered) or received from A to B.

In the description of the present disclosure, the order of each step should be understood as non-limiting unless the preceding step needs to be logically and temporally performed necessarily before the following step. In other words, except for the above exceptional cases, even if the process described as the following step is performed before the process described as the preceding step, the nature of the disclosure is not affected, and the scope should also be defined regardless of the order of the steps. In this specification, “A or B” is defined to mean not only selectively indicating either one of A and B, but also including both A and B. In addition, in the present disclosure, the term “include” has a meaning encompassing further including other components in addition to elements listed as included.

In this disclosure, only essential components necessary for the description of the present disclosure are described, and components unrelated to the essence of the present disclosure are not mentioned. In addition, it should not be interpreted as an exclusive meaning that includes only the mentioned components, but should be interpreted as a non-exclusive meaning that may include other components.

In addition, in the present disclosure, ‘value’ is defined as a concept including a vector as well as a scalar value. In the present disclosure, the expressions such as ‘compute,’ and ‘calculate’ may be replaced by an expression that produces a result of the corresponding computation or operation. In addition, unless otherwise stated, an operation on an encrypted message to be described below means a homomorphic operation. For example, an addition of a homomorphic encrypted message means a homomorphic addition of two homomorphic encrypted messages.

Mathematical operations and calculations of each step of the present disclosure to be described below may be implemented as computer calculations by the known coding method and/or coding designed to suit the present disclosure in order to perform the corresponding operations or calculations.

Specific equations to be described below are illustratively described among possible alternatives, and the scope of the present disclosure should not be construed as being limited to equations mentioned in the present disclosure.

For convenience of description, in the present disclosure, a notation is defined as follows.
a←D: select element (a) according to distribution (D)
s₁, s₂ ∈R: Each of s₁ and s₂ is an element belonging to set R.
mod (q): Modular operation with element q
[symbol] · [symbol] : Round-off internal value

Hereinafter, diverse embodiments of the present disclosure will be described in detail with reference to the accompanying drawings.

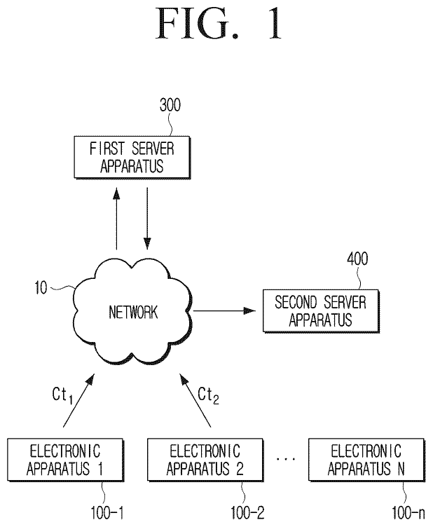

FIG. 1 is a view for describing an operation of an electronic system according to an embodiment of the disclosure.

Referring to FIG. 1, an electronic system may include a plurality of electronic apparatuses 100-1 to 100-n, a first server apparatus 300, and a second server apparatus 400, each of which may be connected to each other through a network 10. The electronic systems may be referred to as an auction system, a network system, a homomorphic encryption systems, etc.

The network 10 may be implemented in various types of wired and wireless communication networks, broadcasting communication networks, optical communication networks, cloud networks, etc., and each apparatus may also be connected through methods such as Wi-Fi, Bluetooth, near field communication (NFC), etc., without a separate medium. The first server apparatus 300 may generate a secret key, a public key, an operation key, etc., to be used for generating and/or calculating, etc., a homomorphic encrypted message, and may provide the public key and/or the operation key to each electronic apparatus and/or the second server apparatus 400.

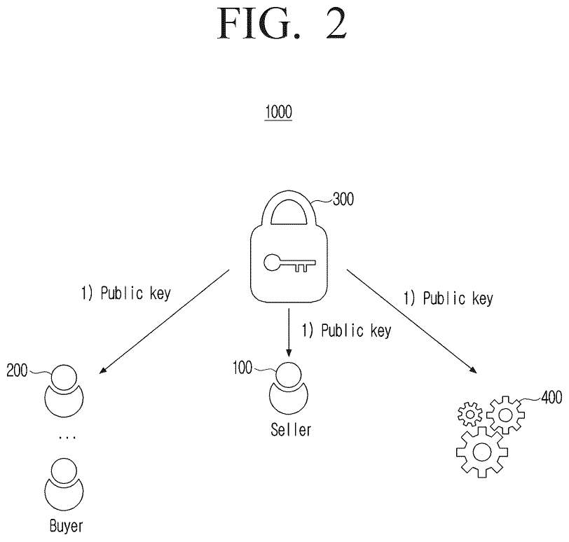

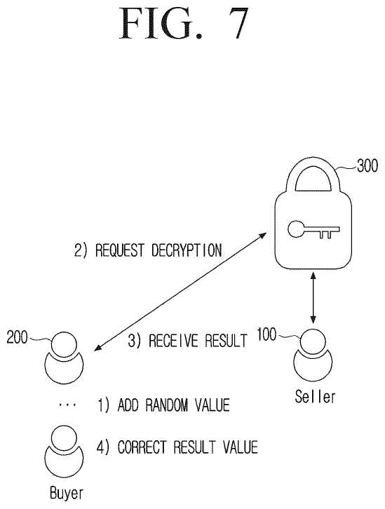

The first server apparatus 300 may store the secret key and decrypt the received homomorphic encrypted message into plaintext in response to a request from another apparatus. The specific operation of the first server apparatus 300 will be described later with reference to FIG. 2 and FIG. 7.

Users may input various types of information through the electronic apparatuses 100-1 to 100-n they use. The input information may be stored in the electronic apparatuses 100-1 to 100-n themselves. Here, the information may include price information for participating in an auction for an auction item. The auction item may include not only an item having an actual object, but also various items that can be traded, such as digital assets.

Each of the electronic apparatuses 100-1 to 100-n may include encryption noise, i.e., an error, calculated during performing homomorphic encryption in an encrypted message. Specifically, the homomorphic encrypted message generated by each of the electronic apparatuses 100-1 to 100-n may be generated in a form in which a result value including a message and an error value is restored when decrypted later using a secret key.

For example, when the homomorphic encrypted messages generated by the electronic apparatuses 100-1 to 100-n are decrypted using a secret key, the homomorphic encrypted message may be generated in a form that satisfies the following natures.

$$Dec ( ct , sk ) = < ct , sk > = M + e ( mod q ) \qquad [ Equation 1 ]$$

Here, <,>denotes a usual inner product, ct denotes an encrypted message, sk denotes a secret key, M denotes a plaintext message, e denotes an encryption error value, and mod q denotes a modulus of an encrypted message. q should be selected to be greater larger than a result value M obtained by multiplying a scaling factor A by a message. When an absolute value of the error value e is sufficiently small compared to M, a decryption value M+e of the encrypted message is a value that may replace the original message with the same precision in significant figure calculation.

When a size of the message is too small or too large, the size may be adjusted using a scaling factor. When the scaling factor is used, not only an integer type message but also a real number type message may be encrypted, and thus, the usability of the message may be greatly increased. In addition, by adjusting the size of the message using the scaling factor, a size of an area where messages exist in the encrypted message after the operation is made, that is, a size of an effective area may also be adjusted.

For example, each electronic apparatus 100-1 to 100-n may homomorphically encrypt price information required for an auction using a public key and provide the corresponding homomorphic encrypted message to the second server apparatus 400. The homomorphic encrypted message includes price information for participating in an auction, and a bid encrypted message and a bid homomorphic encrypted message may be referred to as an auction encrypted message, etc.

Although FIG. 1 illustrates the plurality of electronic apparatuses 100-1 to 100-n, a plurality of electronic apparatuses are not necessarily used, and one apparatus may be used. For example, the electronic devices 100-1 to 100-n may be implemented as various types of devices such as smart phones, tablets, game players, PCs, laptop PCs, home servers, and kiosks. In addition, the electronic devices 100-1 to 100-n may be implemented in the form of home appliances to which an IoT function is applied.

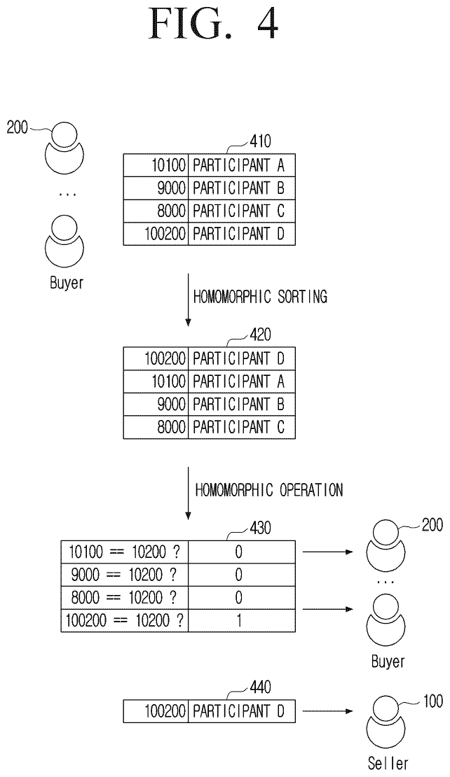

The second server apparatus 400 may perform a preset homomorphic operation using the received homomorphic encrypted message. The detailed operation of the preset homomorphic operation is described later in FIG. 4.

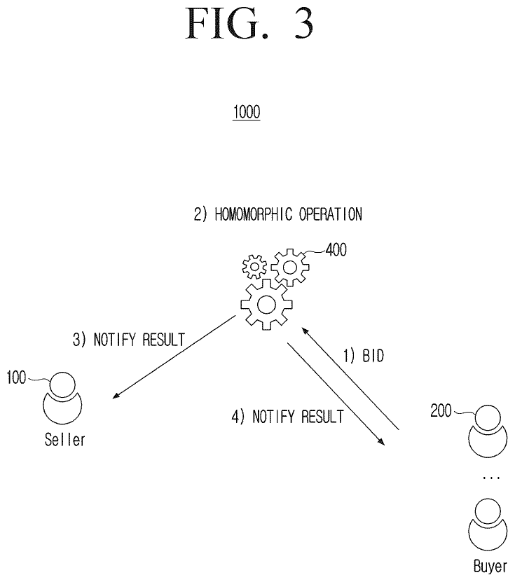

The second server apparatus 400 may provide an operation result to each electronic apparatus 100-1 to 100-n. The specific operation of the second server apparatus 400 is described later in FIGS. 3 to 6.

Due to the nature of the homomorphic encrypted message, the second server apparatus 400 may perform the operation without decryption, and the result value is also in the form of the encrypted message. In the present disclosure, the result value obtained by the operation is referred to as an auction result encrypted message (or a successful bid result encrypted message).

Each electronic apparatus 100-1 to 100-n may receive the auction result encrypted message from the second server apparatus 400 and confirm the auction result using the received auction result encrypted message. In this case, since each electronic apparatus 100-1 to 100-n does not have a secret key, it may decrypt the auction result using the first server apparatus 300 and confirm the auction result using the decrypted result. In this process, each electronic apparatus 100-1 to 100-n may also perform a homomorphic operation that adds a random value to the received encrypted auction result message. This operation is described later in FIG. 7.

Meanwhile, some of the plurality of electronic apparatuses 100-1 to 100-n may be the electronic apparatus of an auction participant (or a buyer, a bidder, etc.) who wants to win an auction item. In addition, at least one of the plurality of electronic apparatuses 100-1 to 100-n may be an electronic apparatus of a seller who has put up the auction item.

Hereinafter, for ease of description, the electronic apparatus 100 that puts up an auction item is referred to as a seller, and an electronic apparatus 200 that provides price information is referred to as a bidder. Hereinafter, the electronic apparatus is referred to as a person, but these references are for the compilation of explanations, not for the actions of real people.

The seller may generate information on the auction item, etc., and provide the generated information to the second server apparatus 400. This information may be in a plaintext state, not the homomorphically encrypted state. For example, the above-described information may include auction item information, auction deadline information, etc., for item A. The second server apparatus 400 may generate an auction number, etc., based on the received information, and disclose an auction schedule, etc.

In this case, the seller may set an auction method, an auction condition, etc., for the auction item. For example, an auction method in which one person bids the highest price, an auction method in which two people bid the highest price, and an auction method in which the second-highest price won the bid, etc., may be used. In addition, a minimum bid price may be set.

Meanwhile, the application of such conditions may be applied as a process of selecting a general successful bidder and then confirming whether the corresponding successful bidder satisfies the corresponding conditions, and conversely, the corresponding conditions may be used as filtering conditions in the homomorphic operation process.

For example, in the case of the condition where the minimum bid amount is 1 million won and only one person who offers the highest bid amount becomes a successful bidder, the first method may be implemented as a method for selecting a bidder who has offered the highest bid amount and then confirming whether the corresponding bidder has offered more than 1 million won. That is, the first method may be a method for confirming whether the condition is satisfied in a process of a seller confirming the finally selected successful bidder information.

The second method is to filter the condition of 1 million won described above in the homomorphic operation process. For example, an algorithm may be used to perform a homomorphic subtraction operation between the homomorphically encrypted price information and the homomorphic encrypted message corresponding to the homomorphic encrypted 1 million won, and change the price information to 0 when the result is negative.

The third method is a method for adding a homomorphic encrypted message corresponding to a price of 1 million won, separately from the homomorphic encrypted messages received from multiple bidders in the homomorphic operation process for selecting the successful bidder. When all the multiple users bid at a price less than 1 million won, the highest price becomes arbitrarily added 1 million won and no bidder won the bid, thereby achieving the above-described conditions. When there are multiple successful bidders, the above-described price may be added corresponding to the number of successful bidders.

Based on the auction schedule, multiple bidders may participate in the bidding by homomorphically encrypting the price information for bidding on the corresponding auction item. Meanwhile, in order to facilitate the description, only the price information is provided to the second server apparatus 400, as illustrated and described, but during implementation, the login (or user authentication procedure), etc., to the auction environment provided by the second server apparatus 400 may be performed in advance.

In addition, the bidder may generate his/her own information (or user information, an IP address of an electronic apparatus, ID information) along with the above-described price information, in addition to the above-described price information. In addition, the second server apparatus 400 determines and notifies the format, etc., of the homomorphic encrypted message to be transmitted for appropriate operation processing, and each bidder may generate the homomorphic encrypted message according to the format. For example, in one of the above-described formats, a first slot of the homomorphic encrypted message may include homomorphically encrypted price information, and a second slot thereof may include homomorphically encrypted ID information.

More detailed operations for such an auction process are described below with reference to FIGS. 2 to 7.

FIG. 2 is a diagram for describing a key distribution operation according to an embodiment of the present disclosure.

Referring to FIG. 2, an electronic system 1000 may include the first server apparatus 300, the first electronic apparatus 100, the second electronic apparatus 200, and the second server apparatus 400.

The first server apparatus 300 may generate a secret key, a public key, etc., required for homomorphic encryption. In addition, the first server apparatus 300 may provide the public key, the operation key, etc., excluding the secret key to other devices 100, 200, and 400. The first server apparatus 300 may be referred to as a key generation device, a keygen device, a keygen server, a key generation server, etc.

When generating a key by itself, the first server apparatus 300 may generate a public key using a Ring-LWE technique. Describing in detail, the first server apparatus 300 may first set various parameters and rings. Examples of the parameters may include a length of bits of a plain text message, a dimension k, a rank k, a size of public and secret keys, and the like. There are various formats for the homomorphic encrypted message, and the first server apparatus may set the ring according to the encrypted message method according to the method set by the user or the predetermined method. For example, the above-described homomorphic encrypted message scheme may be a CKKS scheme, a RLWE scheme, etc.

The ring may be represented by the following Equation.

$$R = {Z}_{q} [ X ] / f ( x ) \qquad [ Equation 2 ]$$

Here, R denotes a ring, Z_{q} denotes a coefficient, and f(x) denotes an n-th polynomial.

The ring is a set of polynomials having predetermined coefficients, and means a set in which addition and multiplication are defined between elements and which is closed for addition and multiplication. Such a ring may be referred to as an annulus.

For example, the ring means a set of n-th polynomials having a coefficient Z_{q}. Specifically, when n is Φ(N), it refers to polynomials that may be calculated as the remainder of dividing the polynomial by an N-th cyclotomic polynomial. f(x) denotes ideal of Z_{q} [x] generated by the f(x). The Euler totient function Φ(N) means the number of natural numbers that is coprime to N and smaller than N. When Φ_{N}(x) is defined as an N-th cyclotomic polynomial, the ring may also be represented by Equation 3 as follows.

$$R = {Z}_{q} [ X ] / {Φ}_{N} ( x ) \qquad [ Equation 3 ]$$

When such a ring is set, the first server apparatus 300 may calculate the secret key sk from the ring.

$$sk ← ( 1 , s ( x ) ) , s ( x ) ∈ R \qquad [ Equation 4 ]$$

Here, s(x) means a polynomial generated randomly with small coefficients.

When the ring and secret key are selected, the first server apparatus 300 calculates a first random polynomial a(x) from the ring. The first random polynomial may be expressed as follows.

$$a ( x ) ← R \qquad [ Equation 5 ]$$

In addition, the first server apparatus may calculate an error. Specifically, the first server apparatus 300 may extract an error from a discrete Gaussian distribution or a distribution statistically close to the discrete Gaussian distribution. This error may be expressed as follows.

$$e ( x ) ← Dn α q \qquad [ Equation 6 ]$$

When the error is calculated, the first server apparatus may calculate a second random polynomial by performing a modular operation on the error in the first random polynomial and the secret key. The second random polynomial may be expressed as follows.

$$b ( x ) = - a ( x ) s ( x ) + e ( x ) ( mod q ) \qquad [ Equation 7 ]$$

Finally, a public key pk is set as follows in a form including the first random polynomial and the second random polynomial.

$$pk = ( b ( x ) , a ( x ) ) \qquad [ Equation 8 ]$$

Since the above-described key generation method is only an example, it is not necessarily limited thereto, and it goes without saying that the public key and the secret key may be generated by other methods. In addition, the operation keys required for homomorphic operations may also be generated.

The first server apparatus 300 may provide the generated public key to the other devices 100, 200, and 400 within the electronic system 1000.

When the public key is distributed in this way, the second electronic apparatus 200 may generate the homomorphic encrypted message using the obtained public key. The second electronic device may be referred to as a buyer, a bidder, a buying device, a bidding device, etc.

The other devices 100, 200, and 400 within the electronic system 1000 can receive the operation key from the first server apparatus 300 and perform the homomorphic operation using the received operation key. For example, the second server apparatus 300 may perform the homomorphic operation for selecting a successful bidder using the received homomorphic encrypted message and operation key. This will be described with reference to FIG. 3.

In this electronic system 1000, since only the first server apparatus 300 has the secret key, the other devices 100, 200, and 400 other than the first server apparatus 300 do not have the secret key and therefore may not perform decryption, so the information is not leaked during the processing of the homomorphic encrypted message.

That is, even if someone obtains the homomorphic encrypted message corresponding to the auction result, the first electronic apparatus 100 or the second electronic apparatus 200 may not understand the result only with the received result (i.e., the homomorphic encrypted message). Therefore, the first electronic apparatus 100 or the second electronic apparatus 200 may decrypt the received homomorphic encrypted message using the first server apparatus 300 and confirm the decryption result.

However, in this method, the second server apparatus 400 does not know the auction result, but the first server apparatus 300 may know the auction result. To exclude this possibility, the first electronic apparatus 100 or the second electronic apparatus 200 may apply one time pad (OTP) before decryption using the first server apparatus 300. This will be described in more detail with reference to FIG. 7.

FIG. 3 is a diagram for describing an operation of collecting bidding information according to an embodiment of the present disclosure.

Referring to FIG. 3, the electronic system 1000 may include the first electronic apparatus 100, second electronic apparatuses 200-1, 200-2, . . . , 200-n, and the second server apparatus 400.

The first electronic apparatus 100 is an electronic apparatus of a user selling an auction item and is notified of the auction result. Such an auction result may be a homomorphic encrypted message including a winning bid price and buyer information. The first electronic apparatus 100 may confirm the winning bidder information and the winning bid price by decrypting the homomorphically encrypted auction result as described in FIG. 2.

The second electronic apparatus 200 is an electronic apparatus of a bidder for an auction item, and may transmit a homomorphic encrypted message including price information for the auction item to the second server apparatus 400.

In addition, the second electronic apparatus 200 may transmit bidder information together. The corresponding bidder information may be transmitted separately from the homomorphic encrypted message described above, included in the homomorphic encrypted message, or a combination of the two forms.

In addition, the second electronic apparatus 200 may receive the auction result from the second server apparatus 400. In addition, the second electronic apparatus 200 may confirm whether the bid is successful by decrypting the homomorphically encrypted auction result as described in FIG. 2. The second electronic apparatus 200 has different information from the first electronic apparatus 100. For example, the second electronic apparatus 200 may simply receive only whether the bid is successful.

The second server apparatus 400 may receive the homomorphic encrypted message in which the price information is homomorphically encrypted from each of the plurality of second electronic apparatuses 200.

Then, the second server apparatus 400 may perform the homomorphic operation of selecting a successful bidder using the plurality of homomorphic encrypted messages received, and provide the result to the first electronic apparatus 100.

In addition, the second server apparatus 400 may also generate information on whether each second electronic apparatus 200 won the bid, and provide the information to each of the second electronic apparatuses 200. Meanwhile, although the above description describes providing the auction result to both a seller and a buyer, the second server apparatus 400 may provide the auction result only to the seller and may not provide the auction result to each bidder during implementation.

In this case, the successful bidder may be informed that the bid was won through the seller's contact, and the unsuccessful bidder may be informed that the bid was not won when there is no separate contact for a certain period of time after the auction decision.

Hereinafter, a specific homomorphic operation process in the second server apparatus 400 will be described with reference to FIG. 4.

FIG. 4 is a diagram for describing an operation of performing a homomorphic operation according to an embodiment of the present disclosure.

Referring to FIG. 4, the second server apparatus 400 can generate a merged encrypted message 410 in which the price information is included in the first slot and buyer information is located in the second slot by using the received homomorphic encrypted message.

The reason for using this merged encrypted message is that parallel processing is possible when the encrypted message is packed and processed, and therefore, the operation speed is fast. That is, the merged encrypted message is created and used in the present disclosure because it is advantageous in terms of speed, but it is also possible to assign a separate index to each homomorphic encrypted message and perform sorting using the assigned index, without using the merged encrypted message during the implementation.

The merged encrypted message may be referred to as a merged encrypted messages, a packing encrypted message, packing data, etc.

The illustrated example illustrates that four pieces of bid information are included, but during implementation, three or fewer pieces of bid information may be used, and five or more pieces of bid information may be included. The buyer information may be a user ID, an index number (or a unique user number (e.g., resident registration number, employee number, etc.)) corresponding to the user ID, etc. The illustrated example illustrates that only the price information and buyer information are included, but during implementation, the merged encrypted message may further include various other information.

When the merged encrypted message is generated, the second server apparatus 400 may perform sorting based on the value of the first slot within the merged encrypted message. For example, the sorting may be performed in ascending or descending order based on the price in the first slot. For example, during the sorting process between a third row (participant C) and a fourth row (participant D) of the merged encrypted message 410, the price of the fourth row is higher, so the order of the third row and the fourth row may be exchanged.

In the above, for the sake of easy description, it is described that the value is checked and the order of the rows is changed accordingly, but in the homomorphic encrypted message, the internal value may not be known, and the above-described process is performed by a certain homomorphic operation.

That is, although it was described as a comparison of two values, the homomorphic operation for this may be a homomorphic operation (e.g., max (A, B)) that receives two values and outputs a higher value in an upper column, and a homomorphic operation (e.g., min (A, B)) that receives two values and outputs a lower value in a lower column. A technology for performing sorting on homomorphic encrypted messages is already known, and therefore, the existing known technology is used for the technology.

When the sorting is performed in this way, it may be confirmed that the information inside a merged encrypted message 420 is sorted in descending order based on slot 1.

When the auction method is a method in which a user who offers the highest price won the bid, the buyer information included in a first row of the illustrated merged encrypted message 420 becomes a successful bidder. In this case, the second server apparatus 400 may extract only the data of the first row in the merged encrypted message and provide a corresponding extracted encrypted message 440 to the seller.

Meanwhile, when a user who offers the second highest price won the bid during implementation, the buyer information included in the second row of the illustrated merged encrypted message 420 becomes a successful bidder.

A seller who receives the extracted encrypted message 440 may confirm the information on the winning bid price and the successful bidder by decrypting the received encrypted message 440.

Hereinafter, the homomorphic operation for each bidder to know whether the bid was successful is described.

The second server apparatus 300 may perform a preset homomorphic operation 430 between the first slot (i.e., the winning bid price) of the first column of the merged encrypted message 420 and the price information of each bidder. The preset homomorphic operation may be a homomorphic comparison operation. In other words, it may be the homomorphic operation that compares whether the price offered by the bidder and the winning bid price are the same.

As a result of the homomorphic operation, the bid price that is the same as the winning bid price has a value that becomes 1 when decrypted, and the bid price that is different from the winning bid price has a value that becomes 0 when decrypted. In the above description, it is described that the bid price is 1 when the bid price is the same as the winning bid price and 0 when the bid price is not the same as the winning bid price, but during implementation, an algorithm that outputs 0 if they are the same and 1 if they are different may be used. Alternatively, an algorithm that outputs values other than 0 or 1 may be used.

Therefore, each bidder who has received the above-described homomorphic operation result may know whether he or she has won the bid by decrypting the received operation result. For example, participant D, who offers a price of 100200, may see that he/she won the bid since the decrypted value is 1. Conversely, participants A, B, and C, excluding participant D, may see that the decrypted value is 0, indicating that he/she won the bid.

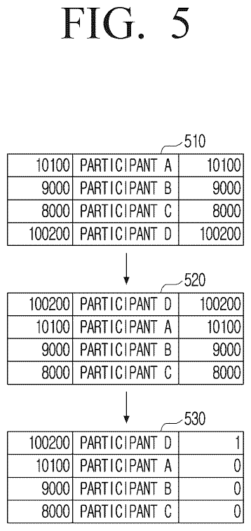

Meanwhile, although the operation of informing the bidder of the auction result is shown above as being performed separately from the merged encrypted message, it may be performed within the merged encrypted message during implementation. This will be described below with reference to FIG. 5.

FIG. 5 is a diagram for describing an example of merging bidding data according to an embodiment of the present disclosure.

Referring to FIG. 5, the second server apparatus 400 generates a merged encrypted message 501 having the same price information in the first slot and the third slot. Accordingly, the merged encrypted message 501 may have a bid price located in a first slot, buyer information located in a second slot, and a bid price located in a third slot. In the illustrated example, the price information may be located in the first slot and the third slot, but this is an example, and during implementation, the buyer information may be located in the first slot, and the price information may be located in the second slot and the third slot. In addition, an additional slot may be provided for storing other information in addition to the information described above.

When the merged encrypted message 501 is generated, the homomorphic sorting operation may be performed on a row-by-row basis based on the price described in the first slot. The homomorphic sorting operation has been described in FIG. 4, and therefore, a redundant description thereof will be omitted.

When an encrypted message 502 in which prices are sorted is generated, the second server apparatus 400 may perform the homomorphic operation between the price information within the third slot using the price information of the first row. Here, the operation is, for example, the homomorphic operation that determines whether the winning bid price and the price within the third slot are the same.

Accordingly, it can be seen as a result of the operation that an encrypted message 503 has a value indicating whether the bid is successful in the third slot. For example, it can be seen that a first row in the third slot is the winning bidder price and has a value of 1, and the remaining rows in the third slot have a value of 0.

Therefore, the second server apparatus 400 may provide the data of the third slot to each bidder to provide the winning bid result. All of the information of the first row of the encrypted message 503 as a result of the operation can be provided to the buyer.

The operation of FIG. 5 as described above is the same as the method described above in terms of the actual homomorphic operation method, but the only difference is that the calculations required to generate the information to be provided to bidders are not performed individually, but are performed collectively within the merged encrypted message. In other words, the above-described homomorphic operation may be performed in the merged encrypted message state, that is, in a parallel operation method, so that the operation processing may be performed more quickly.

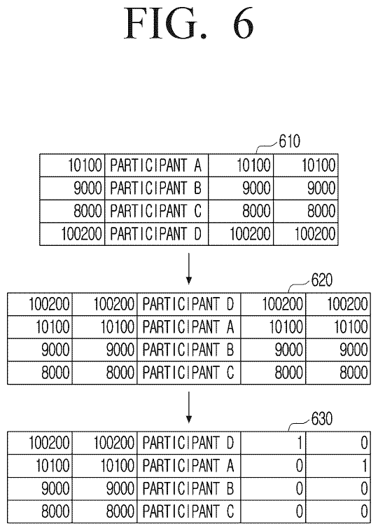

Meanwhile, although the method for selecting one successful bidder was described above, it is also possible to select multiple successful bidders during implementation. This will be described below with reference to FIG. 6.

FIG. 6 is a diagram for describing an example of merging bidding data according to another embodiment of the present disclosure.

Referring to FIG. 6, the embodiment of FIG. 6 is an auction method for selecting two successful bidders. Accordingly, it can be confirmed that two pieces of additional price information corresponding to the number of multiple successful bidders are added when generating the merged encrypted message.

When such a merged encrypted message 610 is generated, the homomorphic sorting may be performed to generate a sorted homomorphic encrypted message 620. The sorting method is the same as the method described in FIG. 4, and therefore, a redundant description thereof will be omitted.

When such a sorted homomorphic encrypted message 610 is generated, the second server apparatus 400 may perform the homomorphic operation between the price information of the first row and the information of the third slot, and perform the homomorphic operation between the price information of the second row and information of a fourth slot. In this way, in the embodiment of FIG. 6, the homomorphic operation was described for two slots assuming the case of two successful bidders, but in the case where there are three or more successful bidders, the homomorphic operation corresponding to the number of successful bidders may be performed by applying the above-described method.

It can be confirmed that a homomorphic operation result 630 generated according to such an operation has a value of 1 in the third slot of the first row and a value of 0 in the fourth slot. It can be seen that, in the second row, the third slot has a value of 0 and the fourth slot has a value of 1.

Meanwhile, during implementation, the data of the third and fourth slots may be notified to each bidder as the auction result, and can also be homomorphically operated and provided to each bidder as a single data.

For example, when the auction results are provided as a plurality of pieces of information such as the third slot and the fourth slot, the successful bidders may be able to know whether they won the first or second place bid.

In cases where it is necessary to hide the winning bid rank, there may be a method for randomly selecting the rank to be multiplied by the third slot or the fourth slot. For example, there may be the method for performing a calculation using a second-rank price information in the third slot and the first-rank price information in a fifth slot. Such changes may be changed in each auction process or may be changed on a row-by-row basis. For example, in odd rows, the first-rank price information may be applied to the third slot, so the homomorphic operation may be performed, and in even rows, the first-rank price information may be applied to the fourth slot, so the homomorphic operation may be performed.

Alternatively, it may be performed through the calculation of the information of the third slot and the information of the fourth slot. For example, in the previous process, the form of having a value of 1 when two values are the same and a value of 0 when two values are different is used, but conversely, a homomorphic comparison operation of having a value of 0 when two values are the same and a value of 1 when two values are different may be used. In this case, the first or second place will have one value of 0 and one value of 1, and the third place and below will have only a value of 1. Therefore, when performing homomorphic multiplication between the third slot and the fourth slot, the first and second rows have a value of 0, and the third row and below have a value of 1.

Meanwhile, although the method for using only one piece of price information is described above, the plurality of pieces of price information may be used during implementation. In this case, the second server apparatus 400 may first perform the homomorphic operation of calculating a final price (or evaluation criteria) and then perform the sorting operation using the result.

In addition, it is also possible to use logical values instead of using only numerical values. For example, a method for multiplying a logical value (e.g., 0 or 1) by a preset numerical value and performing homomorphic addition with a specific numerical value may be used. For example, a subscription system may apply the homomorphic operation that adds a certain score (e.g., 2) to a subscription score if the child information has a value of 1 for a specific numerical value depending on whether there are children.

FIG. 7 is a diagram for describing a process of decrypting an auction result according to an embodiment of the present disclosure.

As described above, when the decryption request is made for the homomorphic operation result as it is, the first server apparatus 300 may know all the information. In other words, the first server apparatus 300 may know who the successful bidder is in the auction.

Therefore, when the auction result is received, the second electronic apparatus 200 may apply the OTP method to the received auction result (1). Specifically, the second electronic apparatus 200 may request the decryption by adding an arbitrary value to the homomorphic result (20). Here, the arbitrary value may be a random value.

Since the value to which the random value is added is decrypted in this way, the first server apparatus 300 may know the decrypted value, but since the corresponding decrypted value is a random value applied as described above, the decrypted result may not be known.

For example, as described above, when ‘0’ indicates a non-successful bid and ‘1’ indicates a successful bid, the second electronic apparatus 200 may add a random value (e.g., 51) to the received result encrypted message. In this case, the first server apparatus 300 may decrypt values of 51 or 52, but since the random value added by the second electronic apparatus 200 is not known, the second electronic apparatus 200 may not know whether the bid is successful. Meanwhile, since this random value proceeds differently for each electronic apparatus, learning is impossible.

Therefore, when the second electronic apparatus 200 receives the decrypted result from the first server apparatus 300 (3), it is possible to apply the previously reflected random value to the received result to confirm the final result (4). For example, when 52 is received, the second electronic apparatus 200 may perform an operation of subtracting the previously added random value (e.g., 51) from the received decrypted data (e.g., 52)) to confirm the final value. Then, the second electronic apparatus 200 may use the confirmed final value to confirm whether the bid is successful and display the result to the user.

In the above, it is described that only the homomorphic operation of simply adding the random value to the result is performed, but during implementation, a plurality of random values may be used instead of one random value. In the process, not only the addition operation but also various homomorphic operations such as subtraction, multiplication, and division may be used.

In addition, although the above description describes that the first server apparatus 300 possesses the secret key and performs the decryption operation with the possessed secret key, a method may also be used in which the secret key and the public key are generated for each auction, and when the auction is completed, the first server apparatus 300 provides the secret key to each of the electronic apparatuses 100 and 200 to cause each electronic apparatus to decrypt the received information.

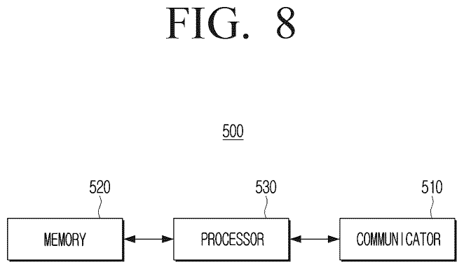

FIG. 8 is a block diagram illustrating a configuration of the electronic apparatus according to an embodiment of the disclosure. The electronic apparatus of FIG. 8 may operate as the second server apparatus 400 of FIG. 1.

Referring to FIG. 8, the electronic apparatus 500 may include a communicator 510, a memory 520, and a processor 530.

The communicator 510 is a component for performing communication with the external device. The communicator 510 may be implemented in a form that includes at least one of a wireless communication module that performs communication according to various wireless communication standards such as a Wi-Fi module, a Bluetooth module, an infrared communication module, zigbee, 3rd generation (3G), 3rd Generation Partnership Project (3GPP), long term evolution (LTE), LTE-advanced (LTE-A), 4th generation (4G), 5th generation (5G), etc., or an input/output interface such as a high definition multimedia interface (HDMI), a mobile high-definition link (MHL), a universal serial bus (USB), a display port (DP), thunderbolt, a video graphics array (VGA) port, an RGB port, D-subminiature (D-SUB), a digital visual interface (DVI), etc., and is not limited thereto, and various forms of communication methods may be used. The communicator 510 may be referred to as a communication interface or a transceiver, but is described as a communication unit in this specification. The communicator 510 may provide various signals and data received from external devices to the processor 530, and transmit various signals and data to various external devices under the control of the processor 530.

For example, the communicator 510 may receive a homomorphic encrypted message from a plurality of other electronic apparatuses. In this case, the homomorphic encrypted message may include price information or include price information and buyer information. Meanwhile, the buyer information may be received separately from the homomorphic encrypted message during implementation.

In addition, the communicator 510 may transmit an encrypted message as a result of the operation to the plurality of other electronic apparatuses. The encrypted message as a result of this operation may be different from the one provided to a seller and the one provided to a bidder. For example, the encrypted message provided as a result of the operation to the seller may include the winning bid price and the buyer information. The encrypted message provided as a result of the operation to the bidder may include only information indicating whether the bid is successful.

The memory 520 is a component for storing various programs, data, and instructions required for the operation of the electronic apparatus 500. In FIG. 2, it is illustrated as a single memory 520 separate from the processor 530, but the number, type, location, etc., of the memory may be implemented variously according to the embodiment. Specifically, the memory 520 may be implemented in various forms such as RAM, ROM, buffer, cache, flash memory, HDD, external memory, and memory card, but is not limited to any one.

The memory 520 may store the received homomorphic encrypted message, the merged encrypted message generated during the operation process, etc.

The processor 530 may control the overall operation of the electronic apparatus 500. For example, the processor 530 may perform operations such as generating the merged encrypted message, the homomorphic sorting, the result notification, etc., according to an embodiment of the present disclosure by executing at least one instruction stored in the memory 520. The processor 530 may be composed of a single device such as a central processing unit (CPU) and an application-specific integrated circuit (ASIC), or may be composed of a plurality of devices such as a CPU and a graphics processing unit (GPU).

When the processor 530 receives the plurality of homomorphic encrypted messages, the processor 530 may generate the merged encrypted message using the received homomorphic encrypted messages. For example, the processor 530 may generate one merged encrypted message, in which one piece of price information is located in one first slot and the buyer information corresponding to the price information is located in a second slot of the same column, using the plurality of received homomorphic encrypted messages.

Meanwhile, during implementation, the processor 530 may generate the merged encrypted message in a form in which the plurality of pieces of price information is located in a plurality of slots. Here, the number of slots to which the price information is added may correspond to the number of successful bidders.

The processor 530 may sort the plurality of pieces of price information using the sorting method corresponding to the auction method for the auction item. For example, the processor 530 may perform sorting on a column-by-column basis using information in the first slot in the merged encrypted message.

The processor 530 may control the communicator to notify the electronic apparatus corresponding to a seller of price information corresponding to a preset rank among the sorted price information and buyer information corresponding to the price information. For example, the processor 530 may control the communicator to notify the electronic apparatus corresponding to the seller of the price information and the buyer information within the column corresponding to the preset rank.

The processor 530 may control the communicator to transmit a result of a preset homomorphic operation between price information transmitted from a corresponding electronic apparatus and price information corresponding to the preset rank to each of the plurality of electronic apparatuses. Here, the preset homomorphic operation may be a homomorphic operation that has a value of 1 or 0 upon decryption depending on whether two pieces of homomorphically encrypted numerical information are identical.

For example, the processor 530 may control the communicator to perform the preset homomorphic operation between each of the third slots of the sorted merged encrypted message and the price information corresponding to the preset rank, and transmit the result of the preset homomorphic operation in the third slot to each of the plurality of electronic apparatuses.

As described above, the electronic apparatus according to the present embodiment performs the process of selecting a successful bidder in a homomorphically encrypted state, so the electronic apparatus performing the auction may not know the information of the successful bidder or the successful bid price at all.

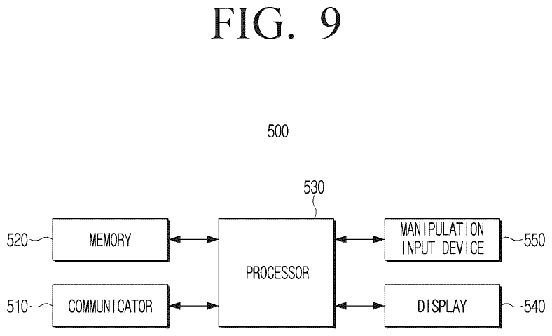

Meanwhile, although only a simple configuration of the electronic apparatus is illustrated and described in FIG. 8, additional configurations that are not illustrated may be used during implementation. This will be described below with reference to FIG. 9.

FIG. 9 is a block diagram illustrating a configuration of the electronic apparatus according to the embodiment of the disclosure. The electronic apparatus of FIG. 9 may operate as the second server apparatus 400 of FIG. 1. In addition, the electronic apparatus 500 may also operate as the first electronic apparatus 100 of FIG. 3, the second electronic apparatus 200 of FIG. 3, and the first server apparatus 300 of FIG. 1.

In the following, for ease of description, the contents related to all functions of each device of FIG. 1 are described, but during implementation, only some functions corresponding to the functions of each device may be performed.

Referring to FIG. 9, the electronic apparatus 500 may include the communicator 510, the memory 520, the processor 530, a display 540, and a manipulation input device 550.

Since the communicator 510, the memory 520, and the processor 530 are described above with reference to FIG. 8, in addition to the operation as the second server apparatus 400 in FIG. 1, only the function when operating as the first server apparatus 300 or the electronic apparatus 100 in FIG. 1 will be described.

The communicator 510 may provide the public key to another electronic apparatus. The communicator 510 may provide the homomorphic encrypted message to another electronic apparatus, or receive the homomorphic operation result or the decryption result.

The memory 520 may store random information used in the OTP process.

Alternatively, the memory 520 may include device information, etc. In addition, when the memory 520 operates as the first server apparatus 300, it may also store information such as the generated secret key.

The display 540 is configured to display various screens. The display 540 may be implemented in various forms such as a liquid crystal display (LCD), an organic light emitting diode (OLED), a liquid crystal on silicon (LCoS), a digital light processing (DLP) projector, a quantum dot (QD) display panel, and the like. The display 540 displays various messages or screens under the control of the processor 530.

The display 540 may display price information for bidding and auction result information. For example, the display 540 may display a user interface window for receiving price information to be used for auction bidding or display the auction result.

In addition, when operating as the first server apparatus 300, the display 540 may display a user interface window for receiving parameters, etc., required for generating various keys.

The manipulation input device 550 may receive bidding information. Such a manipulation input device may be implemented as a keyboard, a mouse, etc., and may also be implemented as a touch screen combined with the above-described display 540.

The processor 530 may control the overall operation of the electronic apparatus 500. For example, the processor 530 may perform functions such as the electronic apparatus of FIG. 1, the first server apparatus of FIG. 1, and the second server apparatus of FIG. 1 by executing at least one instruction stored in the memory 520.

First, the operation of the processor 530 when operating as the first server apparatus 300 will be described. When a preset event occurs, the processor 530 may generate the secret key and the public key. Then, the processor 530 may control the communicator 510 so that the generated public key is distributed.

Then, when receiving the decryption request from another device, the processor 530 may control the communicator 510 to decrypt the received homomorphic encrypted message using the secret key and transmit the decryption result to the corresponding electronic apparatus.

Hereinafter, the operation of the processor 530 when operating as a seller will be described.

When a user specifies an item to be auctioned, the processor 530 may control the communicator 510 to provide the information on the auction item to the second server apparatus 400.

When the auction result is received, the processor 530 may request the first server apparatus 300 to decrypt the auction result. In this case, the processor 530 may add an arbitrary value to the received encrypted message of the auction result so that the first server apparatus 300 may not know the auction result, provide the encrypted message to which the arbitrary value is added to the first server apparatus 300, and upon receiving the decryption result in response thereto, confirm the final auction result by applying the added arbitrary value to the received result.

When the auction result is received from the first server apparatus 300, the display 540 may be controlled to display the received auction result.

The processor 530 may control the communicator 510 to perform a series of operations for transmitting the auction item to the successful bidder based on the device information included in the decryption result. For example, when the auction item is electronic data, the processor 530 may control the communicator 510 to transmit the corresponding item to the corresponding successful bidder when payment of cost, etc., is confirmed.

Hereinafter, the operation of the processor 530 when operating as a bidder will be described.

When the processor 530 receives price information from a user, it may generate the homomorphic encrypted message including the input price information. Then, the processor 530t may control the communicator 510 to transmit the generated homomorphic encrypted message.

When the auction result is received from the second server apparatus 400, the electronic apparatus 200 may request the first server apparatus 300 to decrypt the corresponding result. In this case, the processor 530 may add an arbitrary value to the received encrypted message of the auction result so that the first server apparatus 300 may not know the auction result, provide the encrypted message to which the arbitrary value is added to the first server apparatus 300, and upon receiving the decryption result in response thereto, confirm the final auction result by applying the previously added arbitrary value in reverse to the received result.

When the auction result is received from the first server apparatus 300, the display 540 may be controlled to display the received auction result.

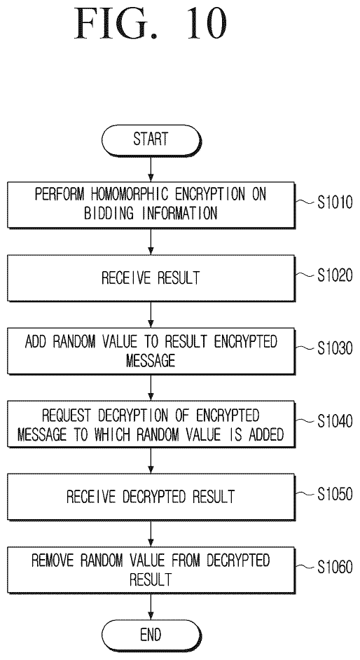

FIG. 10 is a flowchart for describing an operation of controlling the electronic apparatus according to an embodiment of the present disclosure.

Referring to FIG. 10, an electronic apparatus corresponding to a bidder participating in an auction may generate a homomorphic encrypted message including price information set by a user or calculated automatically.

Then, the generated homomorphic encrypted message may be transmitted to an intermediary device (or auction device) that mediates an auction.

In response to the transmission, the homomorphic encrypted message corresponding to the auction result may be received from the intermediary device. Such a homomorphic encrypted message may be an encrypted message that has a value of 1 when decrypted if the auction item won the bid, and a value of 0 when decrypted if the auction item did not win the bid. Such a value of 0 or 1 is an example, and may be implemented to be applied in reverse or to have a different value.

As described above, since each electronic apparatus only has a public key and does not have a secret key, the electronic apparatus may request a server having a decryption key (or private key) to decrypt the corresponding homomorphic encrypted message and receive the decryption result in response thereto.

Meanwhile, in this process, since the server with the decryption key may know the result of each electronic apparatus, each electronic apparatus may add a preset random value before transmitting the homomorphic encrypted message to the server. Then, when receiving the decryption result from the server, the electronic apparatus 200 may remove the above-described random value from the received decryption result and confirm the final result.

For example, assuming that the received auction result is a homomorphic encrypted message corresponding to 1 indicating a successful bid, the electronic apparatus can perform homomorphic addition of homomorphically encrypted messages corresponding to a random value 101 among the auction results. When the homomorphic addition result is decrypted by the server, the decryption result 102 is received from the server, and the electronic apparatus may remove the random value 101 added to the decryption result to finally obtain a value of 1. Meanwhile, when the received auction result is a value of 0 indicating a successful bid, the random value 101 is subtracted from the value 101 received from the server to finally obtain a value of 0.

Through this process, the electronic apparatus may determine whether the bid is successful by only comparing the value received from the server with the random value without performing the process of subtracting the random value. For example, when the value received from the server is the same as the added random value, it is not a successful bid, and when they are different, it may be determined that the bid is successful.

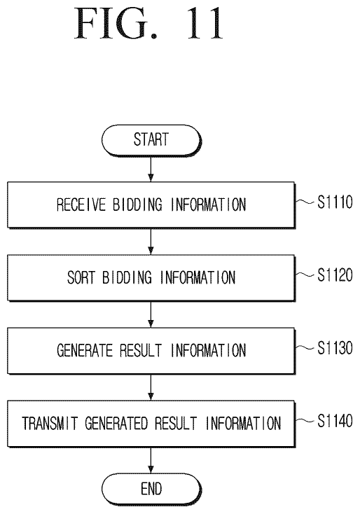

FIG. 11 is a flowchart for describing a method for processing an encrypted message in an electronic apparatus according to an embodiment of the present disclosure.

Referring to FIG. 11, a homomorphic encrypted message including homomorphically encrypted price information for an auction item is received from each of a plurality of different electronic apparatuses.

Then, the plurality of price information is sorted using the sorting method corresponding to the auction method of the auction item.

For example, first, the processor may generate one merged encrypted message, in which one piece of price information is located in one first slot and the buyer information corresponding to the price information is located in a second slot of the same column, using the plurality of received homomorphic encrypted messages. Then, the sorting may be performed on a column-by-column basis using the information in the first slot within the merged message.

The electronic apparatus corresponding to the seller is notified of the price information corresponding to a preset rank among the sorted price information and the buyer information corresponding to the price information (S1140).

The result of the preset homomorphic operation between the price information transmitted from the corresponding electronic apparatus and the price information corresponding to the preset rank may be transmitted to each of the plurality of electronic apparatuses. Here, the preset homomorphic operation may be a homomorphic operation that has a value of 1 or 0 upon decryption depending on whether two pieces of homomorphically encrypted numerical information are identical.

When the merged encrypted message is used, the price information and buyer information within the column corresponding to the preset rank may be notified to the electronic apparatus corresponding to the seller. In addition, the merged encrypted message in which the price information is located in the first slot and the third slot may be generated, the preset homomorphic operation between each of the third slots of the sorted merged encrypted message and the price information corresponding to the preset rank may be performed, and the result of the preset homomorphic operation in the third slot may be transmitted to each of the plurality of electronic apparatuses.

Meanwhile, although the above description assumes that there is only one successful bidder, it may also be applied to an auction environment in which there are multiple successful bidders. In this case, the merged encrypted message having the plurality of third slots corresponding to the number of successful bidders is generated, and each of the plurality of third slots may perform the preset homomorphic operation between the price information of different ranks.

When settlement is performed in this manner, various operations are performed on the received homomorphic encrypted message, but since such operations are performed in the homomorphic encrypted message state, the intermediary may not know which bidder was successful or at what price at all. In addition, even if no information is exposed to the intermediary, the seller may know which bidder was successful at what price.

In addition, the bidder also does not provide the bidding information he or she has written to the intermediary, and when the bidder is not successful, the bidding price set by the bidder is not disclosed to anyone.

Meanwhile, the above-described methods according to at least some of various embodiments of the present disclosure may be implemented in a form of application that may be installed in the existing electronic apparatus.

In addition, the above-described methods according to at least some of various embodiments of the present disclosure may be implemented only by software upgrade or hardware upgrade of the existing electronic apparatus.

Further, the above-described methods according to at least some of various embodiments of the present disclosure can also be performed through an embedded server included in the electronic apparatus or an external server of at least one of the electronic apparatus.

Meanwhile, according to an embodiment of the disclosure, various embodiments described above may be implemented by software including instructions stored in a machine-readable storage medium (for example, a computer-readable storage medium). A machine may be an apparatus that invokes the stored instruction from the storage medium and may be operated depending on the invoked instruction, and may include the electronic apparatus (for example, the electronic apparatus A) according to the disclosed embodiments. When a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory storage medium.

Here, the ‘non-transitory storage medium’ means that the storage medium is a tangible device, and does not include a signal (for example, electromagnetic waves), and the term does not distinguish between the case where data is stored semi-permanently on a storage medium and the case where data is temporarily stored thereon. For example, the ‘non-transitory storage medium’ may include a buffer in which data is temporarily stored. According to an embodiment, the methods according to various embodiments disclosed in the present document may be included and provided in a computer program product. The computer program product may be traded as a product between a seller and a purchaser. The computer program product may be distributed in the form of a machine-readable storage medium (for example, compact disc read only memory (CD-ROM)), or may be distributed (for example, download or upload) through an application store (for example, Play Store™) or may be directly distributed (for example, download or upload) between two user devices (for example, smartphones) online. In a case of the online distribution, at least some of the computer program products (for example, downloadable app) may be at least temporarily stored in a machine-readable storage medium such as a memory of a server of a manufacturer, a server of an application store, or a relay server or be temporarily created.

Various embodiments of the present disclosure according to the claims and detailed description may be implemented through hardware, software, or a combination of hardware and software.

Such software may be stored on a non-transitory computer-recordable storage medium. The non-transitory computer-readable storage medium stores one or more computer programs (or software modules), and the one or more computer programs may include computer-executable instructions that cause an electronic apparatus to perform the method of the present disclosure when executed individually or collectively by one or more processors of the electronic apparatus.

Any such software may be stored in a storage device such as a ROM, a volatile storage device, or a non-volatile storage device, regardless of whether the software can be erased or rewritten, stored in a memory, such as a RAM, a memory chip, a device, or an IC, or stored on an optical or magnetically readable medium, such as a CD, a DVD, a magnetic disk, or a magnetic tape. The storage device and the storage medium may be various embodiments of a computer program including instructions that implement various embodiments of the present disclosure when executed or a non-transitory machine-readable storage medium suitable for storing the computer program. Accordingly, various embodiments may provide a program including a code for implementing an apparatus or method as described in any one of claims of this specification, and a non-transitory machine-readable storage device storing such a program. Although the contents of the present disclosure have been illustrated and described with reference to various embodiments, it will be understood by those skilled in the art to which the present disclosure pertains, and it goes without saying that changes in various forms and details are possible without departing from the gist of the present disclosure as defined by the attached claims and equivalents thereto.

1. An electronic apparatus, comprising:
a communicator configured to receive a homomorphic encrypted message including homomorphic encrypted price information for an auction item from each of a plurality of other electronic apparatuses;
a memory configured to store at least one instruction; and
a processor configured to execute the at least one instruction,
wherein the processor is configured to sort the plurality of pieces of price information using a sorting method corresponding to an auction method for the auction item, and
control the communicator to notify an electronic apparatus corresponding to a seller of price information corresponding to a preset rank among the sorted price information and buyer information corresponding to the price information.

2. The electronic apparatus as claimed in claim 1, wherein the processor is configured to control the communicator to transmit a result of a preset homomorphic operation between price information transmitted from a corresponding electronic apparatus and price information corresponding to the preset rank to each of the plurality of electronic apparatuses.

3. The electronic apparatus as claimed in claim 2, wherein the preset homomorphic operation is a homomorphic operation that has a value of 1 or 0 upon decryption depending on whether two pieces of homomorphically encrypted numerical information are identical.

4. The electronic apparatus as claimed in claim 1, wherein the processor is configured to generate one merged encrypted message, in which one piece of price information is located in one first slot and the buyer information corresponding to the price information is located in a second slot of the same column, using the plurality of received homomorphic encrypted messages.

5. The electronic apparatus as claimed in claim 4, wherein the processor is configured to perform sorting on a column-by-column basis using information within a first slot of the merged encrypted message, and
control the communicator to notify the electronic apparatus corresponding to the seller of price information and buyer information within the column corresponding to the preset rank.

6. The electronic apparatus as claimed in claim 4, wherein the merged encrypted message has price information located in the first slot and third slots, and
the processor is configured to perform a preset homomorphic operation between each of the third slots of the sorted merged encrypted message and the price information corresponding to the preset rank, and
control the communicator to transmit a result of the preset homomorphic operation in the third slots to each of the plurality of electronic apparatuses.

7. The electronic apparatus as claimed in claim 6, wherein the processor is configured to generate the merged encrypted message having the plurality of third slots corresponding to the number of successful bidders when the auction method has multiple successful bidders, and
each of the plurality of third slots performs a preset homomorphic operation between price information with different ranks

8. A method for processing an encrypted message in an electronic apparatus, comprising:
receiving a homomorphic encrypted message including homomorphic encrypted price information for an auction item from each of a plurality of other electronic apparatuses;
sorting the plurality of pieces of price information using a sorting method corresponding to an auction method for the auction item; and
notifying an electronic apparatus corresponding to a seller of price information corresponding to a preset rank among the sorted price information and buyer information corresponding to the price information.

9. The method as claimed in claim 8, further comprising:
transmitting a result of a preset homomorphic operation between price information transmitted from a corresponding electronic apparatus and the price information corresponding to the preset rank to each of the plurality of electronic apparatuses.

10. The method as claimed in claim 9, wherein the preset homomorphic operation is a homomorphic operation that has a value of 1 or 0 upon decryption depending on whether two pieces of homomorphically encrypted numerical information are identical.

11. The method as claimed in claim 8, further comprising:
generating one merged encrypted message, in which one piece of price information is located in one first slot and the buyer information corresponding to the price information is located in a second slot of the same column, using the plurality of received homomorphic encrypted messages.

12. The method as claimed in claim 11, wherein in the sorting, sorting is performed on a column-by-column basis using information within the first slot of the merged encrypted message, and
in the notifying of the electronic apparatus corresponding to the seller, the price information and the buyer information within the column corresponding to the preset rank are notified to the electronic apparatus corresponding to the seller.

13. The method as claimed in claim 11, further comprising:
performing a preset homomorphic operation between each of the third slots of the sorted merged encrypted message and the price information corresponding to the preset rank; and
controlling the communicator to transmit a result of the preset homomorphic operation in the third slot to each of the plurality of electronic apparatuses,
wherein the merged encrypted message has price information located in the first slot and third slots.

14. The method as claimed in claim 13, wherein in the generating of the merged encrypted message, the merged encrypted message having the plurality of third slots corresponding to the number of successful bidders is generated when the auction method has multiple successful bidders, and
in the performing of the preset homomorphic operation, each of the plurality of third slots performs the preset homomorphic operation between price information with different ranks.

15. A computer-readable recording medium including a program for executing a method for processing an encrypted message,
wherein the method for processing an encrypted message includes:
receiving a homomorphic encrypted message including homomorphic encrypted price information for an auction item from each of a plurality of other electronic apparatuses;
sorting the plurality of pieces of price information using a sorting method corresponding to an auction method for the auction item; and
notifying the electronic apparatus corresponding to a seller of price information corresponding to a preset rank among the sorted price information and buyer information corresponding to the price information.
